(19) United States
(12) Patent Application Publication
(10) Pub. No.: US 2021/0258463 A1
(43) Pub. Date: Aug. 19, 2021

(54) Camera Auto-Flash Optimization and Intelligent Slow Sync Flash Mode

(71) Applicant: Abtin Ghelmansaraei, Danville, CA (US)

(72) Inventor: Abtin Ghelmansaraei, Danville, CA (US)

(21) Appl. No.: 16/792,268

(22) Filed: Feb. 16, 2020

(51) Int. Cl. H04N 5/235; H04N 17/00

(52) U.S. Cl. CPC H04N 5/2351; H04N 5/2354; H04N 17/002

(57) ABSTRACT

Auto-flash and Slow Sync flash modes are the common flash mode settings that are used in modern cameras. Auto-flash turns the camera flash-on when the light level is lower than a preset level. The auto-flash activation light level varies among different cameras. It should be set to a value that satisfies both requirements of a good picture quality and less battery consumption. Slow sync flash mode utilizes a long exposure time to improve the background picture quality and a flashlight to illuminate the foreground. This invention describes: (1) An innovative methodology in finding optimum flashlight activation level for camera auto-flash mode that should be set by the camera manufacturers. This is the setting that camera manufactures must use at camera production/manufacturing. (2) An intelligent and adaptive Slow Sync Flash mode in which the camera senses the scene light level and adjusts the shutter speed for optimized image quality.

### TECHNICAL FIELD

Embodiments presented in this disclosure generally relate to camera flashlight modes.

### BACKGROUND OF THE INVENTION

This invention is related to camera auto-flashlight activation settings and a novel technique to optimize slow sync flash mode. Cameras use flashlights to help capture darker scenes by illuminating them with a brief flash of light. One of the important quality parameters of the camera is to capture good picture quality at lower and darker light conditions.

Low light photography is challenging specifically for mobile cameras as these systems use image sensors with very small pixels that are less sensitive to light and have lower Signal to Noise Ratio (SNR). SNR is the ratio of the signal strength to the background noise and can be measured spatially using a single image or temporally by using more than one images.

SNR is improved by image processing techniques that are integrated into cameras. Specifically, the majority of cameras use ISP (Image Signal Processing), which include denoising and sharpening filters. Noise reduction filters suppress the image noise and result in a higher SNR. The penalty paid by using excessive noise filtering is loss of image details and sharpness. Image sharpness determines the amount of the details of an image. Most ISP use adaptive noise reduction filtering, in which the amount of noise reduction filtering (as well as noise suppression) depends on the lighting conditions. At lower and darker light conditions, ISP applies a stronger and more excessive noise filtering that results in perceptible image detail and sharpness loss.

The flash modes used in almost all mobile cameras are auto-flash, flash-on (or Fill flash), and flash-off. Auto-flash is a technique used in modern cameras to turn on the flashlight automatically. It does this by switching on the camera flash when the light level is lower than a preset level. The auto-flash activation light level varies among different cameras. For mobile cameras (like those on smartphones), it should be set to a value that satisfies both requirements of good picture quality and less battery consumption.

Another flash mode that is commonly used in some cameras is slow sync mode, in which the flash turns on, but the exposure length is longer than that of auto-flash mode. This maintains the ambient background light while allowing the flashlight to illuminate the main subject. By using slow sync flash, images with proper foreground and background illumination can be captured. There are two options for slow sync flash mode: rear curtain sync and front curtain sync. In rear curtain sync, the camera fires the flashlight at the end of exposure. In other words, when the shutter is pressed, the lens aperture opens up, collects ambient light, and activates the flashlight right before the end of exposure. In front sync mode, however, the inverse occurs and the camera fires the flashlight at the start of exposure. The exposure shutter remains open until the end of exposure to collect the ambient light.

### BRIEF DESCRIPTION OF DRAWINGS

FIG. 1: Simplified diagram of the test set up to determine the optimum light activation level for auto-flash.

FIG. 2: An example of the actual test set up with a test chart to find the Samsung Galaxy auto-flash activation level.

FIG. 3: An example of a test chart with highlighted 18% reflection block and line pair with different frequencies for image sharpness analysis.

FIG. 4: Block Diagram and flow chart to find the optimum light settings for auto-flash mode.

FIG. 5: Samsung Galaxy S4 auto-flash turned on at 56 Lux.

FIG. 6: Example of the objective analysis of image sharpness by checking line pair frequency response at different light intensities.

FIG. 7: Slow sync flash mode.

FIG. 8: Flow chart of an intelligent and adaptive Slow Sync flash mode

### DETAILED DESCRIPTION OF SPECIFIC EMBODIMENTS

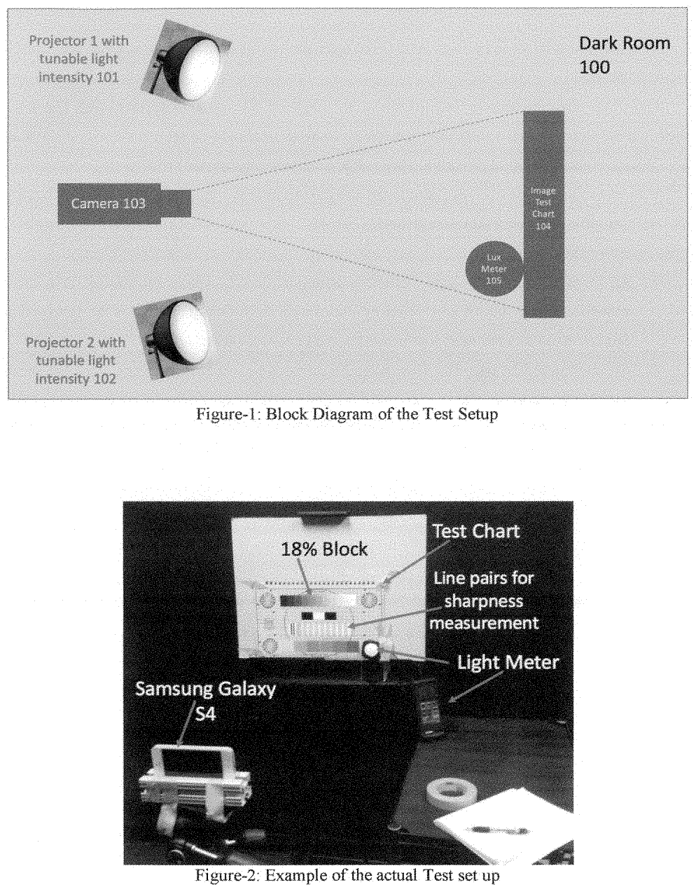

FIG. 1 shows the simplified test setup used to find the optimum light activation level for auto-flash mode. The test equipment was placed inside a Dark room 100 (the only light is generated by Projector-1 101 and Projector-2 102). The Camera 103 that was being used to test the optimum auto-flash light setting was placed in front of an Image Test Chart 104. The two projectors in FIG. 1 illuminated the Test chart 104. The light intensity and color temperature of the projectors (101 and 102) were adjustable. The Color temperature of projectors 101 and 102 were set to the color temperature of the camera flash flight. The light intensity at the surface of Image Test Chart 104 was measured by a Lux Meter 105.

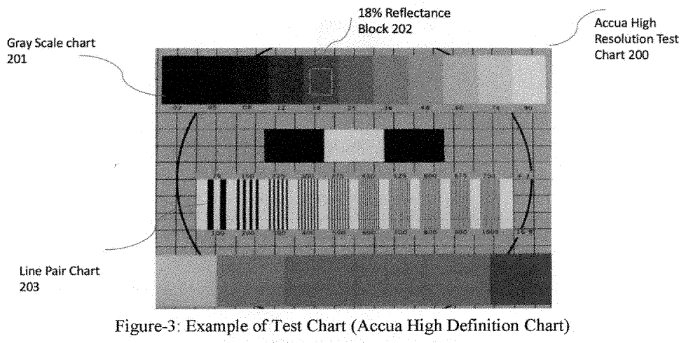

FIG. 2 displays the actual test setup using a Samsung Galaxy S4 camera that was set to auto-flash mode. The test chart included gray scale blocks to allow analysis of the SNR (signal to noise ratio) and evaluation the image sharpness. In FIG. 2, an Accu-High Definition chart is used for image analysis.

FIG. 3 shows the Accua High definition chart with 18% reflectance block. The gray scale blocks with 18% reflectance bar and line pair chart were used for SNR and image sharpness analysis, respectively. To analyze images for SNR and sharpness, first the RGB image was converted to grayscale “Y”. SNR was then calculated by dividing the average of pixels' intensities (Y) within 18% block 202 by standard deviation.

The methodology that was used to determine the correct activation level for the auto-flash was based on image SNR and sharpness analysis. Image SNR and sharpness were analyzed by using image processing tools (such as Matlab, ImageJ, etc). SNR10 is commonly referred to in photography as the 1st acceptable image. SNR10 means that the ratio of image signal to noise is equal to 10. SNR10 was analyzed on 18% reflectance block 202 as the minimum requirement for an acceptable SNR (Note that a different value of SNR can be utilized. In this embodiment, SNR10 is used to explain the procedure to derive the optimum light settings for auto-flash mode). For sharpness analysis, the line frequency response of line pair chart was checked at different TV lines.

To find the optimum activation level of the auto-flash that satisfies both image quality requirements and less battery consumption, the image signal to noise ratio (SNR) and sharpness were analyzed. The justifications that this methodology delivers the optimum flashlight level are:

The light level determines the image SNR.

It is common in photography to use SNR10 as the first Acceptable Image. Therefore, SNR10 was used in this invention disclosure as the minimum SNR requirement.

Camera Image Signal Processing (ISP) contains de-noising filters that are also affected by the light level. This will impact image sharpness.

The noise reduction filters increase the SNR. Excessive filtering reduces the image details/sharpness.

Line pair response analyzed at different TV lines for image sharpness.

The criteria to determine the correct light level for auto-flash activation is the least amount of light intensity that delivers:
a. SNR>=10 without flashlight (for a test chart with 18% reflectance), and
b. No discernible image sharpness loss (e.g., by evaluating the line pair modulation transfer function at different spatial frequencies) compared to brighter images.

Test Methodology to Find Optimum Flashlight Activation Level

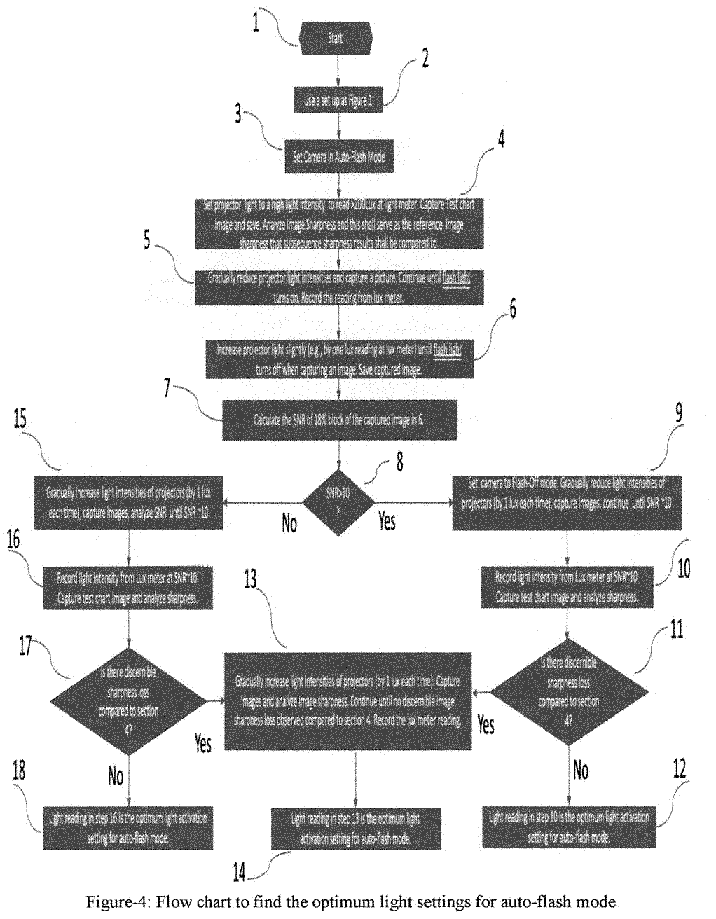

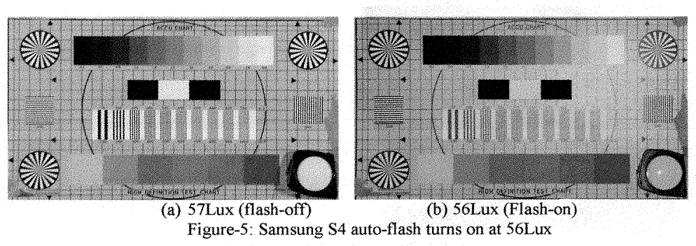

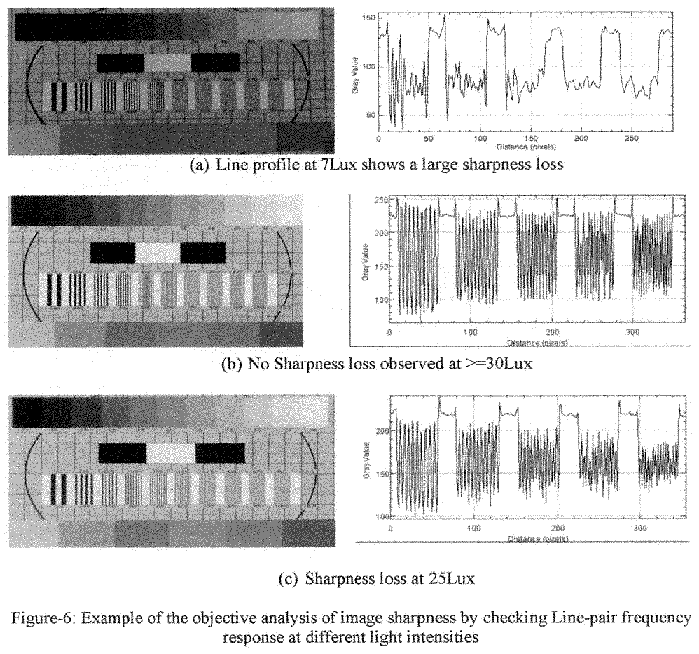

FIG. 4 depicts the flow chart to find the optimum light settings for auto-flash mode. The test flow chart and procedures are as follows:
a. Use the test set up as of FIG. 1 2.
b. Set camera 103 to auto-flash mode 3.
c. Start with very bright light intensities by adjusting Projectors 101 and 102 to read 200 lux or above at Lux Meter 105. Color temperature of projectors 101 and 102 are set to color temperature of camera flash flight. At this light intensity, the flashlight is off. Capture test chart 105 image and save 4. Analyze the image sharpness; this will serve as the reference image sharpness in which the subsequent image sharpness data will be compared to.
d. Gradually reduce projector (101 and 102) light intensities and capture a picture of test chart 105. Continue until flashlight turns on. Record the reading from lux meter 105.
e. Increase projector (101 and 102) light intensities slightly until the light reading of lux meter 105 increased by one lux. The flashlight will turn off. Capture test chart 105 image and save 6.
f. Analyze image for SNR and sharpness by converting RGB to grayscale “Y”. Calculate SNR by dividing the average pixel intensities (Y) within 18% block 202 by standard deviation. Record computed SNR 7.
g. Check whether SNR>10 8.
   i. If ‘Yes’,
      1. Set the camera flash mode to “flash off”. Gradually reduce light intensities of projectors 101 and 102 (by 1 lux each time), capture images, analyze SNR, and continue until the SNR becomes equal to about 10 (SNR-10) for 18% reflectance block 202.
      2. Record light intensity from Lux meter 105 at SNR-10. Capture test chart image and analyze sharpness 10.
      3. Check whether there is a discernible sharpness loss compared to reference sharpness (obtained in block 4 of FIG. 4) 11.
         a. If ‘No’, Light reading in 10 is the optimum light activation setting for auto-flash mode 12.
         b. If ‘yes’,
         I. Gradually increase light intensities of projectors 101 and 102 (by 1 lux each time). Capture images and analyze image sharpness. Continue until no discernible image sharpness loss observed compared to reference sharpness 4. Record the lux meter reading 13.
         II. Light reading in 13 is the optimum light activation setting for auto-flash mode 14.
   ii. If ‘No’,
      1. Gradually increase light intensities of projectors 101 and 102 (by 1 lux each time), capture images, analyze SNR of 18% block 202 until SNR becomes about 10 15.
      2. Record light intensity from Lux meter 105 at SNR-10. Capture test chart image and analyze sharpness 16.
      3. Check whether there is a discernible sharpness loss (compared to reference sharpness 4) 17:
         a. If ‘No’, Light reading in 16 is the optimum light activation setting for auto-flash mode 18.
         b. If ‘Yes’,
         I. Gradually increase light intensities of projectors 101 and 102 (by 1 lux each time). Capture images and analyze image sharpness. Continue until no discernible image sharpness loss observed compared to reference sharpness 4. Record the lux meter reading 13.
         II. Light reading in 13 is the optimum light activation setting for auto-flash mode 14.
h. For the Samsung Galaxy S4 example that was used in FIG. 2, the auto-flash light was activated at 56 lux (5 of FIG. 4). The flashlight was off at 57 lux and above (6 of FIG. 4). FIG. 5 shows the captured images (6 of FIG. 4). SNR of the 18% reflectance block 202 was calculated to be 70.4 at 57 Lux (7 of FIG. 4). Since this was well above the target SNR of 10, the camera was set to “Flash off” mode and the projector lights were reduced (9 of FIG. 4). An SNR of 10.4 was measured at 7 Lux (10 of FIG. 4). This was the least amount of light that provided an SNR of >=10. Next, the image sharpness was checked to determine whether there was a discernible sharpness loss compared to reference sharpness 4 of FIG. 4 (11 of FIG. 4). Referring to the line profiles in FIGS. 6-a and 6-b, there was a large sharpness loss at 7 Lux compared to 30 Lux and higher light intensities (lower amplitude of the line profile on the higher frequency part of ‘line pair chart’ is an indication of image sharpness). Therefore, the 7 Lux did not satisfy both requirements of SNR>=10 (18% reflection block 202) and “no discernible sharpness loss.” Referring to FIG. 6-c, the image sharpness loss started at light intensities lower than 30 lux (13 of FIG. 4). Therefore, 30 Lux is the optimum light setting for auto-flash mode that the camera manufacturer should use (14 of FIG. 4). This is the correct light level that preserves/satisfies the image quality and consumes less battery (since the flashlight, when on, uses a considerable battery power).

Intelligent and Adaptive Slow Sync Flash Mode

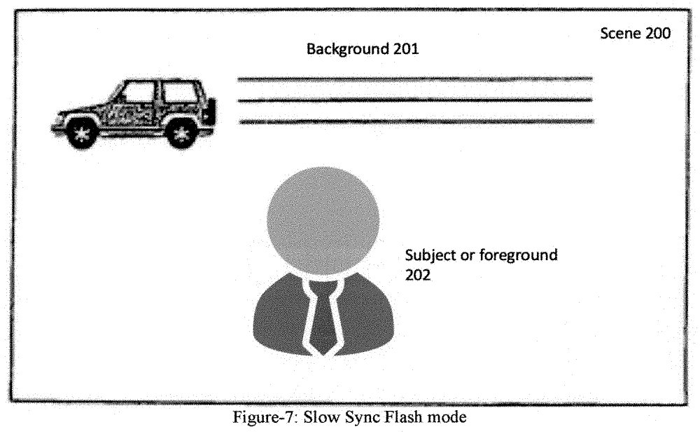

Referring to FIG. 7, the goal of smart flash mode is to balance the background 201 and foreground 202 in a scene 200. In slow sync flash mode, a long exposure is used to capture the background 201 and also a flashlight for foreground 202 actions. This will provide a better background 201 picture quality compared to fill flash or auto-flash mode.

The standard slow sync flash modes are not an intelligent flash mode in which the exposure time for background 201 is adaptive with scene 200 light levels and the auto-flash light activation level (for foreground 202).

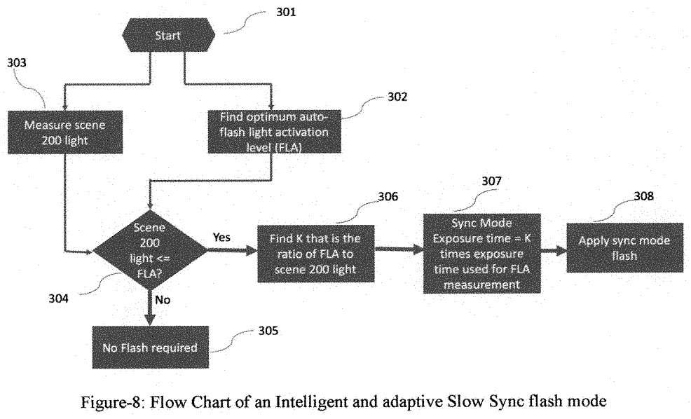

FIG. 8 shows the block diagram of a smart slow sync flash mode. First the optimum auto-flash light activation (FLA) level 302 is determined using the flow chart procedure as detailed in FIG. 4. Then, the scene 200 light intensity is measured 303 (most smartphone cameras have a light meter or light meter app that can be downloaded for light intensity measurements). In 304, the scene 200 light intensity was compared against the FLA level. If scene 200 light level is greater than FLA level, no flashlight is required 305. However, if scene 200 light intensity is smaller or equal to FLA level, then compute ‘K’, which is the scene 200 light level ratio to FLA 306. The sync mode exposure time will be equal to ‘K’ times of default exposure (used for FLA) 307. Apply the sync mode 308 with exposure time of 307.

1. A method comprising:
a camera with an autoflash mode that is switched off;
a test chart containing grayscale with different reflectance blocks and means for sharpness analysis;
placing the test chart at a preset foreground distance around 1 meter from the camera and positioning it orthogonal to the optical axis of the camera lens;
light projectors with adjustable light intensities that have a color temperature close to the camera flash light's color temperature and illuminate the test chart;
a light meter placed next to the test chart to measure the light intensity;
capturing test chart images at different lighting conditions;
image processing software to quantify the Signal to Noise Ratio (SNR) of the test chart within a specific reflectance block (most camera standards use 18%) and predefining the minimum image quality SNR requirement (most camera standards use SNR=10 as the first acceptable image quality);
image processing analysis software to quantitatively or subjectively assess and compare the test chart image sharpness at higher light intensities (about 200 Lux) and lower light intensities;
determining the lowest light level that satisfies both the minimum image quality SNR requirement and produces no discernible loss in image sharpness as determined by analysis of the test chart image;
and then set the camera autoflash light setting to this light level.

2. (canceled)

3. The method of claim 1, wherein the minimum light intensity is determined to set the autoflash light activation level.

4. The method in claim 1, wherein the camera's autoflash light setting satisfies the image quality and low battery consumption requirements that are critical for mobiles cameras.

5. A camera comprising:
an autoflash mode;
the method of claim 1 to determine the autoflash light activation level;
a light meter embedded in the camera to measure the scene's light intensity level;
a process to compare the scene's light level against the autoflash light activation level and to calculate the ratio of the autoflash light activation level to the scene's light intensity level;
a process to change the camera's exposure time if the ratio of autoflash light activation level to the scene's light is greater than 1. The new exposure time will be equal to the ratio of the autoflash light activation level to the scene's light level multiplied by the camera exposure time that was used to measure autoflash light activation level;
and apply the computed exposure time to the slow sync flash mode.

6. The camera in claim 5, wherein a balanced background picture quality compared to foreground exposed by flashlight is delivered.

7. The camera in claim 5, wherein the Slow Sync flash is applicable to both front and rear curtain slow Sync modes.

8. The camera in claim 5, wherein the exposure time is adaptive with the scene light.

9. The camera in claim 5, wherein the exposure time is proportionally increased if the scene light level is lower than the autoflash light activation level. The proportional increase could be the ratio of scene light level to autoflash light activation level.

10. The method of claim 1, wherein a camera manufacturer adjusts the factory settings of the autoflash light activation level to the light level that satisfies the image quality requirements.

11. The camera in claim 5, wherein a light meter in the camera could be a hardware device to measure the light intensity or a light meter software application built into digital camera to measure the light intensity.
